(19) United States
(12) Patent Application Publication
(10) Pub. No.: US 2011/0119431 A1
(43) Pub. Date: May 19, 2011

(54) MEMORY SYSTEM WITH READ-DISTURB SUPPRESSED AND CONTROL METHOD FOR THE SAME

(76) Inventor: Rafat CHOWDHURY, Fuchu-shi (JP)

(21) Appl. No.: 12/882,604

(22) Filed: Sep. 15, 2010

(30) Foreign Application Priority Data
Nov. 13, 2009 (JP) 2009-260510

(51) Int. Cl. G06F 12/02

(52) U.S. Cl. 711/103; 711/E12.008

(57) ABSTRACT

According to one embodiment, a memory system includes a memory and a controller. The memory includes NAND strings. Each of the NAND strings includes memory cells. The memory cells capable of holding data. The memory writing and reading data in units of a page corresponding to a set of the memory cells and erasing data in units of a block corresponding to a set of the NAND strings. The controller controls the memory. The controller includes a holding unit and a control unit. The holding unit holds a table in which information on a check page is recorded, for each zone corresponding to a set of the blocks. The control unit references the table to calculate a read error and instructs the memory to write the data in the block including the check page to another block in the memory, if the occurrence rate exceeds a preset threshold.

### CROSS-REFERENCE TO RELATED APPLICATIONS

This application is based upon and claims the benefit of priority from Japanese Patent Application No. 2009-260510, filed Nov. 13, 2009; the entire contents of which are incorporated herein by reference.

### FIELD

Embodiments described herein relate generally to a memory system and control method for the memory system, including a nonvolatile memory and a memory controller.

### BACKGROUND

An SD memory card is known as an example of a memory system including a nonvolatile memory and a memory controller controls the nonvolatile memory. For example, a NAND flash memory is used as the nonvolatile memory mounted in the SD memory card, which has been disclosed in Jpn. Pat. Appln. KOKAI Publication No. 2009-42911.

In such a memory system, if the number of error bits and the number of data reads performed by a host exceed given thresholds, a refresh operation is performed. Read-disturb measure based on the refresh operation is known. An example of the read disturb measure is a method of holding the number of data reads in the RAM for every plural blocks corresponding to an erase unit for the NAND flash memory.

### BRIEF DESCRIPTION OF THE DRAWINGS

FIG. 1 is a block diagram of a memory system according to a first embodiment;

FIG. 2 is a diagram of the configuration of a register according to the first embodiment;

FIG. 3 is a conceptual drawing of a inspection address table according to the first embodiment;

FIG. 4 is a diagram of the configuration of a memory space according to the first embodiment;

FIG. 5 is a diagram of the configuration of a command output by a host according to the first embodiment;

FIG. 6 is a flowchart showing the operation of a memory controller performed when a data read request is issued according to the first embodiment;

FIG. 7A and FIG. 7B are conceptual drawings showing incrementation in a inspection address table according to the first embodiment;

FIG. 8A and FIG. 8B are conceptual drawings showing incrementation in the inspection address table according to the first embodiment;

FIG. 9 is a flowchart showing the operation of a memory controller performed when a data write request is issued according to the first embodiment;

FIG. 10 is a block diagram of RAM according to a second embodiment;

FIG. 11A, FIG. 11B, FIG. 11C, FIG. 11D, FIG. 11E, FIG. 11F, and FIG. 11G are conceptual drawings showing incrementation in a inspection address table according to a second embodiment;

FIG. 12 is a conceptual drawing of the RAM according to a third embodiment;

FIG. 13 is a flowchart showing the operation of a memory controller according to the third embodiment;

FIG. 14 is a conceptual drawing of the RAM according to a fourth embodiment; and

FIG. 15 is a flowchart showing the operation of a memory controller according to the fourth embodiment.

### DETAILED DESCRIPTION

Embodiments will be described below with reference to the drawings. In the description, common components are denoted by common reference numbers throughout the drawings.

In general, according to one embodiment, a memory system includes a semiconductor memory and a controller. The semiconductor memory includes a plurality of NAND strings. Each of the NAND strings includes a plurality of memory cells. The plurality of memory cells capable of holding data and connect in series. The semiconductor memory writes and reads data in units of a page corresponding to a set of the memory cells belonging to different NAND strings. The semiconductor memory erases data in units of a block corresponding to a set of the plurality of NAND strings. The controller controls the semiconductor memory. The controller includes a holding unit and a control unit. The controller holds a inspection address table in which information of a page of a block for each zone is recorded. When the data is read from the semiconductor memory, the control unit references the inspection address table to calculate an occurrence rate of a read error for the page of a block included by a zone and the zone is as same as the zone that includes the address specified in the read command. If the occurrence rate exceeds a preset threshold, the control unit instructs the semiconductor memory to copy the data in the block includes the ECC threshold exceeded page to a non allocated erased block.

A memory card will be described below as an example of a memory system according to a first embodiment. Here, a host apparatus is a personal computer or a cellular phone but may be any type of apparatus provided that the apparatus is compatible with the memory system.

### First Embodiment

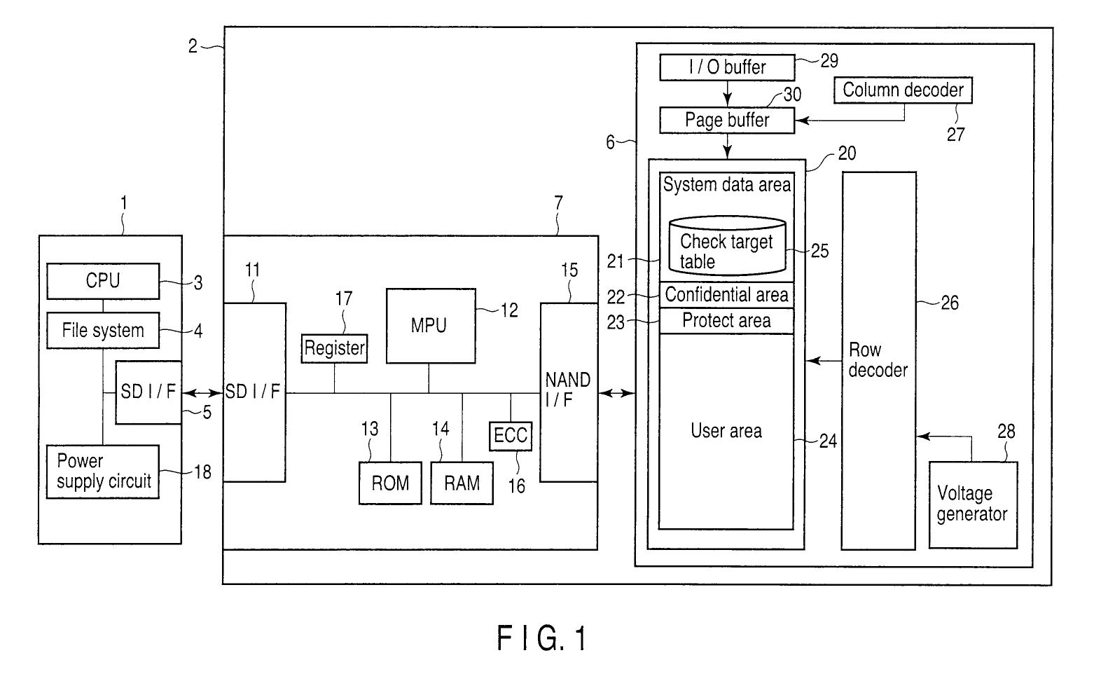

FIG. 1 is a block diagram schematically showing the essential parts of a memory card 2 and of a host apparatus 1 serving as a memory system according to the first embodiment. Each block may be created as hardware, computer software, or a combination of hardware and computer software.

### <Example of Configuration of the Host 1>

With reference to FIG. 1, an example of the configuration of a host apparatus (hereinafter referred to as a host) will be described. The host 1 includes, for example, CPU 3, a file system 4, an SD interface 5 (denoted as SDI/F in the figures), and a power supply circuit 18. For example, the FAT (File Allocation Table) system is used as the file system 4.

The host 1 includes hardware such as CPU 3 which is required to access the memory card 2 inserted into the host 1, and software such as applications and an operating system.

CPU 3 instructs the file system 4 to execute write in accordance with an instruction from a user ordering to write data to the memory card 2. Furthermore, in order to read data from the memory card 2, CPU 3 instructs the file system 4 to read the data from the memory card 2.

Thus, the file system 4 manages files (data) recorded in a certain storage medium (in this case, the memory card 2) to be managed. Specifically, the file system 4 records management information in a storage area in the memory card 2. The file system 4 uses the management information to manage the files. The file system 4 specifies a method for creating directory information such as files and folders in the memory card 2, a method for moving or removing files or folders, a data recording scheme, and in which area the management information is recorded and how to utilize the area.

The host 1 transmits and receives data to and from the memory card 2 via an SD interface 5 provided in the host 1. The host 1 specifies various agreements required for communication with the memory card 2, and issues various commands that may be recognized by the memory card 2. Furthermore, the SD interface 5 of the host 1 has a proper arrangement and number of pins and is configured to be connectable to an SD interface 11 in the memory card 2. Furthermore, the power supply circuit 18 supplies power to the memory card 2.

### <Example of Configuration of the Memory Card 2>

Now, an example of the configuration of the memory card 2 will be described. When the memory card 2 is connected to the host 1 in an on state, the memory card 2 is powered by the host 1 to perform an initialization operation. Thereafter, the memory card 2 may execute one of a write process, a read process, and an erase process in accordance with a command from the host 1.

Similarly, if the memory card 2 is inserted into the host 1 in an off state, and the host 1 is then turned on, the memory card 2 is powered by the host 1 to perform an initialization operation. Thereafter, the memory card 2 may execute one of a write process, a read process, and an erase process in accordance with a command from the host 1.

The memory card 2 includes a NAND flash memory 6 (hereinafter sometimes referred to as a flash memory) and a controller 7 configured to control the NAND flash memory 6.

The controller 7 writes and reads data selected in units of the NAND flash memory 6 called pages each including a plurality of memory cells. A unique physical address is assigned to each page.

Furthermore, the controller 7 erases data in selected units of the NAND flash memory 6 called physical blocks each including a plurality of pages. A physical address is assigned to each physical block.

Thus, the controller 7 manages the storage state of data held by the flash memory 6. The management of the storage state refers to the management of the relationship between the physical addresses of the pages (or physical blocks) and logical addresses of data assigned by the host 1, and the management as to which the physical addresses of pages (or physical blocks) being in an erased state (the state in which no data is written or invalid data is held).

The controller 7 includes the SD interface 11, MPU (Micro Processing Unit) 12, ROM (Read Only Memory) 13, RAM (Random Access Memory) 14, a NAND interface 15, an ECC circuit 16, and a register 17.

The MPU 12 controls the operation of the memory card 2 as a whole. When the MPU 12 detects that the memory card 2 has been turned on, for example by being provided a power from the host 1, the MPU 12 reads firmware (control programs) stored in the ROM 13 onto the RAM 14 and executes a predetermined initial process.

The MPU 12 allows an inspection address table 25 in a system data area 21 to be stored in the RAM 14 in accordance with a control program. Furthermore, the MPU 12 manages data in the inspection address table 25 as required. Moreover, the MPU 12 receives a write command, a read command, and an erase command from the host 1 to execute a predetermined process. Specifically, upon receiving a read command (CMD17 or CMD18) from the host 1, the MPU 12 reads data corresponding to a read address from the flash memory 6.

In particular, in the present embodiment, when the memory card 2 is powered by the host 1, the MPU 12 loads the inspection address table 25 in the system data area, onto the RAM 14. Thereafter, the MPU 12 refers the inspection address table 25 loaded on the RAM 14 based on an address received from the host 1. Based on the data in the inspection address table 25, the MPU 12 instructs an ECC circuit 16 to check (error correction) data held by a corresponding memory cell.

Control programs controlled by the MPU 12 are stored in the ROM 13.

RAM 14 is used as a work area for the MPU 12 and configured to load the control programs and various tables. For example, the tables include a logical address-physical address conversion table allowing the logical address assigned to data by the file system 4 into the physical address of the page in which the data is actually stored.

Furthermore, the RAM 14 may hold the data from the inspection address table 25. That is, as described above, when the memory card 2 is powered by the host 1, the RAM 14 loads the data from the inspection address table 25 held in the system data area 21.

Now, the ECC circuit 16 will be described. The ECC circuit 16 corrects data for errors, and also calculates the rate of occurrence of read errors for the data held in a read page. The rate of occurrence is, for example, the ratio of the number of corrected bits to the total number of bits in memory cells in a page direction.

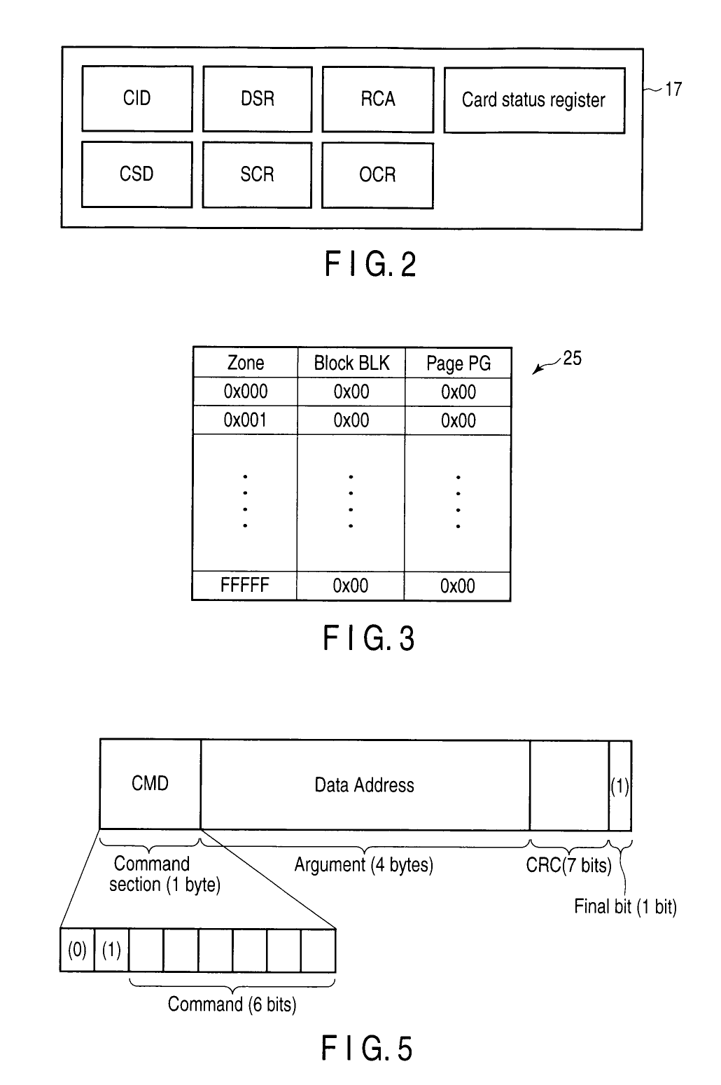

Now, the configuration of the register 17 will be described with reference to FIG. 2. As shown in FIG. 2, the register 17 includes a card status register, CID, RCA, DSR, CSD, SCR, and OCR.

The card status register is used for normal operations and configured to store, for example, error information. CID, RCA, DSR, CSD, SCR, and OCR are used mainly to initialize the memory card 2.

The individual number of the memory cad 2 is stored in CID (Card Identification Number). A relative card address is stored in RCA (Relative Card Address). A bus driving force for the memory card 2 and the like are stored in DSR (Driver Stage Register). Characteristic parameter values for the memory card 2 are stored in CSD (Card Specific Data). The data arrangement in the memory card 2 is stored in SCR (SD Configuration Data Register). An operating voltage is stored in OCR (Operation Condition Register) if the operating range voltage of the memory card 2 is limited.

Now, the inspection address table 25 will be described with reference to FIG. 3. FIG. 3 shows a conceptual drawing of the inspection address table 25.

As shown in FIG. 3, in the inspection address table 25, the block address (logical address) of a block BLK and the page address (logical address) of a page PG to be checked are recorded for each zone Zn. The zone Zn refers to, for example, a set of 512 blocks BLK. For example, the block BLK refers to an erase unit and includes, for example, 128 pages.

In an example shown in FIG. 3, ‘0x000’, ‘0x001’, . . . , ‘FFFFF’ are stored at the logical addresses of the zones Zn in the inspection address table 25 (16-bit notation). Moreover, “0x00” is stored at each of the logical addresses of the blocks BLK and pages PG arranged in the respective columns.

That is, as shown in FIG. 3, in the initial state of the inspection address table 25, in each of the zones Zn, a page included in a block BLK with a leading block address and corresponding to a leading page address is to be checked.

For more specific description, the first row in the inspection address table will be focused on. For the first zone Zn (0x000), memory cells indicating the page addresses (0x00) of a block address (0x00) is to be checked by the ECC circuit 16 (the memory cells correspond to the page:0x00, block:0x00). This also applies to the second row. The addresses of the page PG and block BLK to be checked are incremented by the MPU 12 as required. As shown in FIG. 3, the final logical address of the zone Zn is ‘FFFFF’. The number of zones Zn held by the flash memory 6 according to the present embodiment is assumed to be, for example, 30.

Now, the configuration of the flash memory 6 shown in FIG. 1 will be described. The flash memory 6 includes a storage area 20 in which data is stored, and various control circuits (a row decoder 26, a sense amplifier (included column decoder) 27, a voltage generator 28, an I/O buffer 29, a page buffer 30, and the like).

The storage area 20 is divided into a system data area 21, a confidential area 22, a protect area 23, and a user area 24 in accordance with the type of saved data.

The system data area 21 is provided in the flash memory 6 by the controller 7 in order to save data required for the operation of the controller itself. Mainly the management information on the memory card 2 is stored in the system data area 21. Specifically, security information on the memory card 2 and card information such as a media ID are stored in the system data area. In the present embodiment, the data in the inspection address table 25 and number-of-times data 31 described below are stored in the system data area 21.

Key information for encryption and confidential data for authentication are saved to the confidential area 22. The host 1 cannot access the confidential area 22.

Important data and secure data are stored in the protect area 23. The host 1 may access the protect area 23. However, the host 1 is allowed to access the protect area 23 only when the host 1 is validated through the mutual authentication between the host 1 and the memory card 2.

The user area 24 may be freely accessed and used by the host 1. User data, for example, AV content file and image data, is stored in the user area 24. In the description below, the flash memory 6 refers to the user area 24. The controller 7 obtains a part of the user area 24 and saves control data (the logical address-physical address conversion table, finally assigned logical block addresses described below, and the like) required for the operation of the controller 7 itself to the area obtained. The protect area 23 and the user area 24 are logically formatted into separate volumes and managed as files by the host 1.

For a data write operation, a data read operation, and a data erase operation, the row decoder 26 selects the row direction of the storage area 20 based on a row address provided by a control unit (not shown in the drawings).

The column decoder 27 selects the column direction of the storage area 20 based on a column address provided by the control unit (not shown in the drawings).

The voltage generator generates voltages required for the data write operation, the data read operation, and the data erase operation. The voltage generator 28 supplies the generated voltage to the row decoder 26.

The I/O buffer 29 temporarily holds the write data, address, and command supplied by the controller 7. The I/O buffer 29 outputs each of the address and command to the control unit (not shown in the drawings). Furthermore, the I/O buffer 29 outputs the write data to the page buffer 30. Additionally, the I/O buffer 29 outputs the read data received from the page buffer 30, to the controller 7.

The page buffer 30 temporarily holds the write data received from the I/O buffer 29. The page buffer 30 transfers the write data to the storage area 20. The page buffer 30 also outputs the read data received from the storage area 20, to the memory controller 7 via the I/O buffer 29.

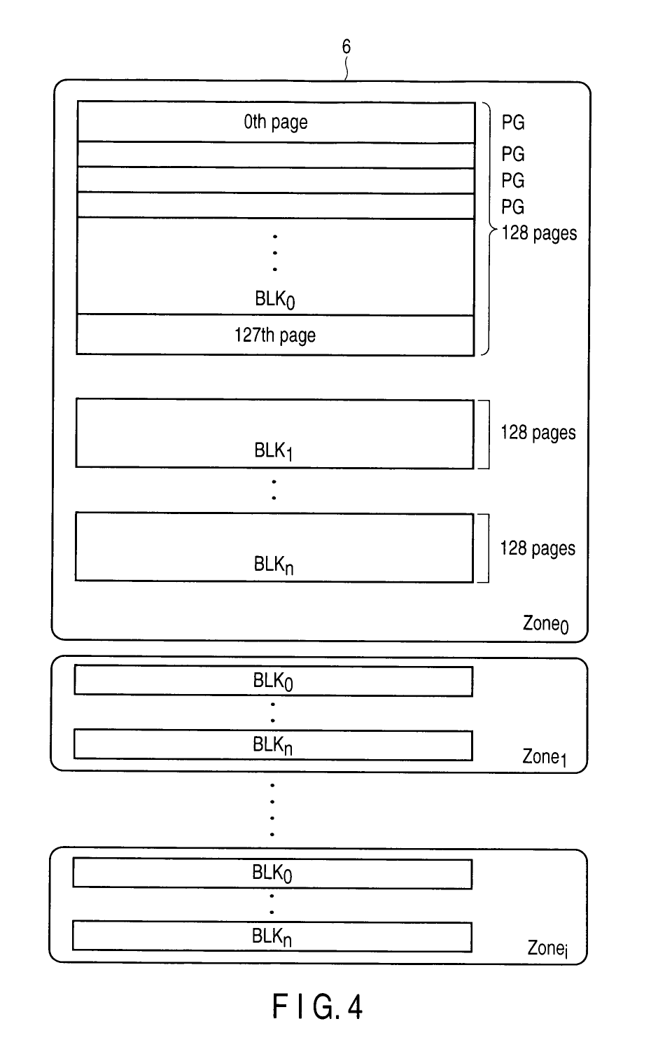

Now, a memory space in the flash memory 6 and the physical configuration of the memory will be described with reference to FIG. 4. As shown in FIG. 4, the flash memory 6 includes a normal memory area and the page buffer 30 (not shown in the drawings). Mainly the memory area will be described below.

The memory area includes a plurality of zones Znᵢ (for example, 0≦i≦29). Each zone Znᵢ includes, for example, 512 blocks BLK. Each physical block BLK includes, for example, 128 pages. When not distinguished from one another, zone Zn₀ to zone Znᵢ are simply referred to the zones Zn. Furthermore, when not distinguished from one another, block BLK₀ to block BLKₙ are simply referred to as the blocks BLK. Moreover, when not distinguished from one another, page PG₀ to page PG₁ are simply referred to the pages PG.

Each memory cell includes MOSFET (Metal Oxide Semiconductor Field Effect Transistor) with what is called a stack gate structure. The MOS transistor with the stack gate structure includes a tunnel insulating film, a charge accumulation layer such as a floating gate electrode, an inter-electrode insulating film, a control gate electrode, and a source/drain diffusion layer. Each memory cell transistor MT has a threshold voltage varying depending on the number of electrons accumulated in the charge accumulation layer. Information corresponding to the difference in threshold voltage is stored in the memory cell transistor MT. The memory cell transistor MT may assume at least two states with different thresholds and is configured to be capable of what is called multivalue storage. The control circuit of the flash memory 6 including the sense amplifier and the voltage generation circuit is configured to be able to write and read multi-bit data to and from the memory cell transistor MT.

The control gate electrodes of the memory cell transistors MT belonging to the same page are connected to the same word line. Furthermore, select gate transistors are provided at the respective opposite ends of the group of memory cell transistors MT connected in series and belonging to the same column; the memory cell transistors MT and the select gate transistors as a whole form a NAND string. One of the select gate transistors is connected to the bit line. The other select gate transistor is connected to a source line. Data read and data write are each performed on each set of a plurality of memory cell transistors MT. The storage area formed by the set of memory cell transistors MT corresponds to one page. That is, the set of memory cell transistors MT included in different NAND strings and connected to the same word line corresponds to one page.

In the example shown in FIG. 4, each page PG includes 2,112 bytes (512 bytes for a data storage unit×4+10 bytes for a redundant unit×4+24 bytes for a management data storage unit). As described above, each block BLK includes, for example, 128 pages. As described above, each zone Zn includes, for example, 512 blocks.

Data read and data write are each performed in units of a page corresponding to the set of memory cell transistors MT. Furthermore, data is erased in units of the block BLK corresponding to the set of pages. The set of blocks BLK corresponds to one zone Zn.

Data read and data write are each performed via the page buffer 30 shown in FIG. 1. That is, for write, write data transferred by the controller 7 is temporarily held by the page buffer 30 and transferred to a bit line. Furthermore, read data read onto the bit line is sensed, amplified, and then temporarily held by the page buffer 30. Thereafter, data in the page buffer 30 is transferred to the controller 7 via the I/O buffer 29.

The size of data that may be held by the page buffer is, for example, the same as that of the page PG, that is, 2,112 bytes (2,048 bytes+64 bytes). During data write and data read, the page buffer 30 holds one page of data for the flash memory.

Furthermore, the flash memory 6 has a mode in which 1-bit data may be written to one memory cell transistor MT and a mode in which multibit data, that is, data with 2ⁿ (n is a natural number) values, is written to one memory cell transistor MT. The mode in which the flash memory writes 1-bit data to one memory cell transistor MT is called a binary mode. The mode in which the flash memory writes multibit data to one memory cell transistor MT is called a multivalue mode.

### <Configuration of Commands>

FIG. 5 is a diagram showing the configuration of a command transferred to the memory card 2 by the host 1. As shown in FIG. 5, the command includes a leading command CMD (1 byte (8 bits)), an argument (data address (4 bytes)), CRC (7 bits), and a final bit (1 bit).

In the command, the leading 2 bits are used as fixed bits. Specifically, data ‘01’ is set in the two bits. The actual command given to the memory card 2 by the host 1 is described in the remaining 6 bits in the command. For example, any of CMD17 (51 h), CMD18 (52 h), and CMD24 (58 h) each indicating a read request as described below is described in the command. The last reference character ‘h’ in the symbol in parentheses indicates that the preceding numbers are hexadecimal.

If the command output by the host 1 is CMD24, a write address is stored in an argument, with corresponding data stored in the flash memory 6.

Furthermore, if the command output by the host 1 is CMD17, a read address is stored in the argument.

When the command is output to the memory card 2 by the host 1, the memory card correspondingly outputs data to the host 1. Operations described below are performed in the memory card 2 during the period from the output of the command from the host 1 until the memory card 2 outputs data to the host 1 in response to the command.

### <Operation of the Memory Card 2 (MPU 12) (1)>

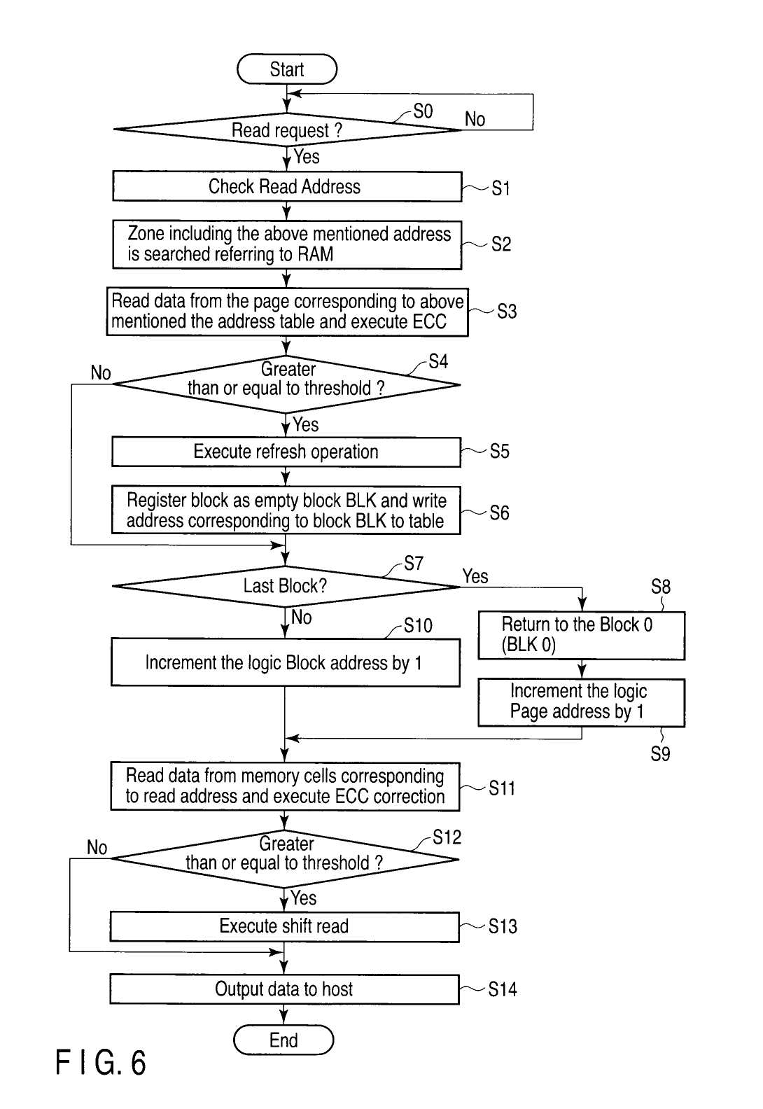

FIG. 6 shows the operation of the memory card 2 (particularly the MPU 12) performed when the host 1 issues a read request to the memory card 2. This operation is performed during the period from the transmission of, for example, CMD17 from the host 1 until the memory card 2 outputs data to the host 1 in response to the transmission.

First, upon receiving the read request, that is, CMD17 or CMD18, from the host 1 (step S0, YES), the MPU 12 checks the address of the read data received from the host 1 (S1).

Based on the address, the MPU 12 references the inspection address table 25 in the RAM 14 to search the ith (0≦i≦29, i: real number) zone Znᵢ including the address received from the host 1 (S2).

MPU 12 reads data from block BLKₙ (0≦n≦511, n: real number) corresponding to zone Znᵢ searched in step S2 and from page PGₗ (0≦l≦127, l: real number) corresponding to block BLKₙ. That is, the MPU 12 reads data from the page PG corresponding to the inspection address. The MPU 12 then allows the ECC circuit 16 to correct the data for possible errors (S3).

Thereafter, the MPU 12 compares the occurrence rate of read errors obtained from the results of the error correction performed on page PGₗ with a preset threshold (S4). If the occurrence rate is greater than or equal to a threshold (S4, YES), the MPU 12 performs a refresh operation on block BLKₙ corresponding to page PGₗ (S5).

That is, the MPU 12 copies block BLKₙ to another empty block BLKₙ in zone Znᵢ, and registers the source block BLKₙ as a new empty block BLK. Then, the MPU 12 writes the logical address corresponding to the destination block BLKₙ to the logical address-physical address conversion table on the RAM 14 (S6).

Thereafter, the MPU 12 determines whether or not block BLKₙ according to the inspection address table 25 is the last of a zone. Where a zone is consists of m logic blocks, and here we assume m=511 (mεNatural Number) (S7). If the result of the determination indicates that BLKₙ is last block of a zone (S7, YES), the MPU 12 increments the logical address of block BLKₙ by 1 bit to return the logical address to the leading address (S8). Simultaneously with the returning of the logical address of block BLKₙ to the leading address, the MPU 12 increments the logical address of page PGₗ by 1 bit (S9).

On the other hand, if block BLKₙ according to the inspection address table in step S7 is not determined to be the last (block BLKₙ is not determined to have the 512th logical address) (S7, NO), the MPU 12 increments the logical address of block BLKₙ by 1 bit (S10). That is, block BLKₙ is changed to block BLK₍ₙ₊₁₎.

If the results of the error correction performed on page PGₗ by the ECC circuit 16 in step S4 indicate that the occurrence rate of read errors is not greater than or equal to the threshold (S4, NO), the MPU 12 proceeds to step S7 without performing the refresh operation.

Then, the MPU 12 reads data corresponding to the address received from the host 1, from the memory cell. The MPU 12 then allows the ECC circuit 16 to correct the read data for possible errors (S11).

Thereafter, the MPU 12 compares the occurrence rate of read errors with the threshold based on the results of the error correction (S12). If the results of step S12 indicate that the occurrence rate of read errors is greater than or equal to the threshold (S12, YES), the MPU 12 executes a shift read on the memory cells (S13). Here, the shift read is an operation performed if data cannot be read normally from the memory cells and in which the read level of the memory cell is changed before a read operation is performed, thus allowing the data held in the memory cells to be read correctly. The MPU 12 executes the shift read and then outputs the data in the memory cells which may now be correctly read, to the host 1.

Furthermore, in step S12, if the results of the error correction performed by the ECC circuit 16 indicate that the occurrence rate of read errors is lower than the threshold (S12, NO), the MPU 12 outputs the data to the host 1 without executing the shift read (S14).

### <Increment Operation Performed on the Inspection Address Table 25 (1)>

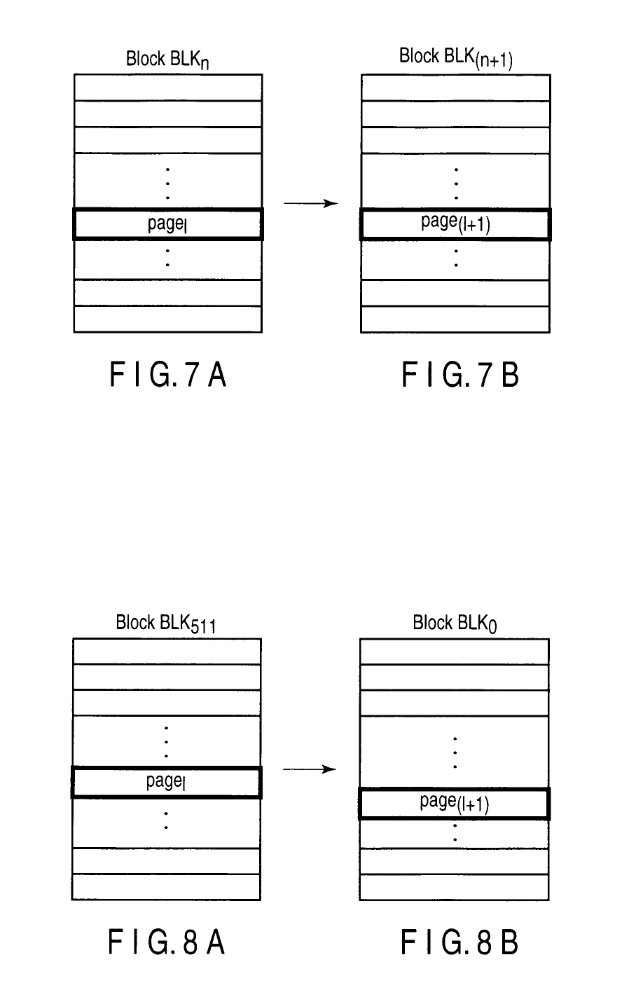

Now, the operation of incrementing the logical address of block BLKₙ in the inspection address table 25 in the RAM 14 as illustrated in steps S7 to S10 will be described with reference to FIGS. 7A, 7B, 8A and 8B.

FIG. 7A shows a inspection page specified by the inspection address table 25 before the host 1 issues a read request to the memory card 2 where considering the address as not the last block of a zone. As shown in FIG. 7A, the inspection page is, for example, page PGₗ in block BLKₙ. Here, the zone Zn is not particularly specified but is assumed to be the Znᵢ. (iεNatural Number)

FIG. 7B shows a inspection page specified by the inspection address table 25 after the host 1 has issued a read request. As shown in FIG. 7B, the inspection page has been changed to page PGₗ in block BLK₍ₙ₊₁₎ (S7 and S10).

That is, upon receiving CMD17 or CMD18 from the host 1, the MPU 12 searches zone Znᵢ including the read address from the host 1. The MPU 12 then increments only the logical address of block BLKₙ in zone Znᵢ. Thus, the block in zone Znᵢ is updated. Hence, such that if the host 1 issues a read request for zone Znᵢ next time, page PGₗ in block BLK₍ₙ₊₁₎ is to be checked.

Now, the case where the inspection address table 25 indicates the last block of a zone will be described with reference to FIGS. 8A and 8B. In this case, the MPU 12 increments the logical addresses of both block BLKₙ and page PGₗ in the inspection address table 25 in the RAM 14.

That is, FIG. 8A shows a inspection page specified by the inspection address table 25 before the host 1 issues a read request to the memory card 2. As shown in FIG. 8A, the inspection page is, for example, page PGₗ in block BLK₅₁₁.

FIG. 8B shows a inspection page specified by the inspection address table 25 after the host 1 has issued a read request. In this case, the inspection page returns to the leading address and is thus changed to page PG₍ₗ₊₁) in block BLK₀.

That is, upon receiving CMD17 or CMD18 from the host 1, the MPU 12 searches zone Znᵢ including the read address and block BLKₙ. When the logical block address of the searched block BLKₙ indicates the last block address of a zone (in this case, the 512th address), the MPU 12 changes the inspection block from block BLK₅₁₁ to block BLK₀ and instead of incrementing the block address, increments the page address by one. Thus, if the host 1 issues a read request for zone Znᵢ, page PG₍ₗ₊₁₎ in block BLK₀ shown in FIG. 8B is to be checked.

### <Write Operation>

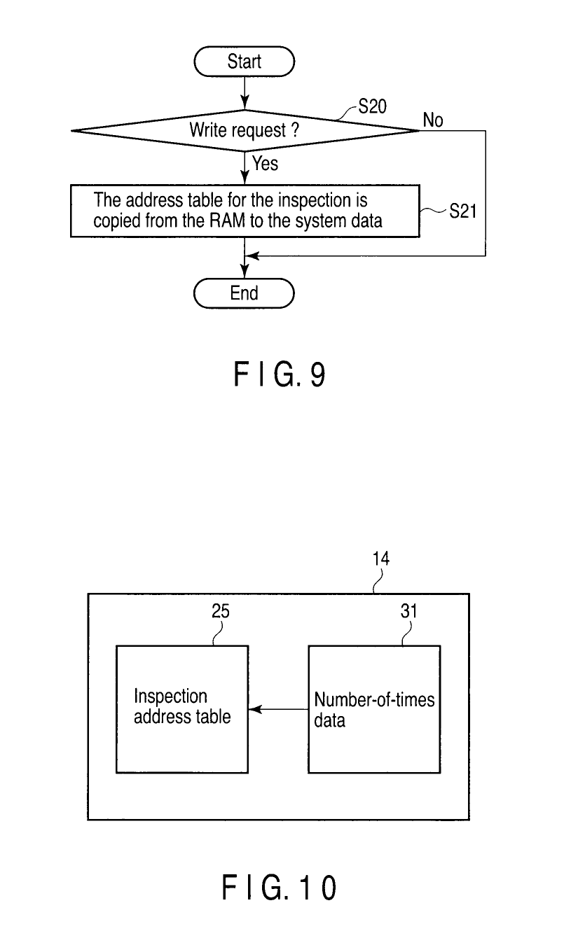

Now, the operation of the MPU 12 performed if the host 1 issues a data write request (CMD24) to the memory card 2 will be described with reference to FIG. 9. FIG. 9 is a flowchart showing a write operation performed by the MPU 12. The operation of writing data to an address specified by the host 1 in response to a write request from the host 1 is omitted.

As shown in FIG. 9, when the host 1 issues a write request to the memory card 2 (step S20, YES), the MPU 12 writes the data in the inspection address table 25 stored in the RAM 14, back into the system data area 21 (S21). That is, the system data area 21 is overwritten with the data in the inspection address table 25. Furthermore, if the host 1 issues no write request to the memory card 2, the MPU 12 avoids storing the data in the inspection address table 25 in the RAM 14, in the system data area 21.

### Effects of the Present Embodiment

The memory system and the control method for the memory system according to the present embodiment may produce the following effect.

(1) Read-disturb may be suppressed with a reduction in the capacity consumption of the RAM 14.

Description will be given in comparison with conventional memory systems. In the description below, the same components of the conventional memory system as those of the present system are denoted by the same reference numbers.

In the conventional memory system, the MPU 12 manages the number of reads for each block BLK. That is, blocks BLK for which the number of reads exceeds a given value are no longer used. This serves to prevent possible read-disturb. Thus, the conventional memory system uses, for example, a read counter to manage the number of reads for each of 512 blocks included in one zone Zn. That is, if the capacity of the management area for the number of reads for one block BLK is 16 bits (=2 bytes), the RAM 14 requires a capacity sufficient to hold the number of reads for each block BLK.

If the capacity of the management area for the number of reads for one block BLK is 16 bits, a capacity of 512 blocks×2 (bytes)=1,024 bytes is required per zone Zn. Moreover, if for example, 30 such zones Zn are formed in the memory 6, a capacity of 1,024 bytes×30=30,720 bytes is required. That is, the RAM 14 requires a capacity of about 30 Kbytes. In addition to having the above-described disadvantage, the above-described management method limits the capacity of the RAM 14 owing to the recently reduced size and increased capacity of memory cells.

In contrast, the present embodiment allows read-disturb to be suppressed while enabling a reduction in the capacity used by the RAM 14.

That is, in the present embodiment, the data managed or stored by the RAM 14 is not the number of reads for each block BLK but the data in the inspection address table 25. That is, the present embodiment has only to be able to hold, for each zone Zn, a 2-byte address indicating which block BLK and page PG of the block BLK are to be checked currently. Specifically, since each block BLK and each page PG may each be expressed by 1 byte, each zone Zn may be expressed by 2 bytes. Thus, if for example, 30 zones Zn are formed in the flash memory 6, a capacity of only 2 bytes×30 zones Zn=60 bytes is required for the flash memory 6 as a whole. Furthermore, the logical addresses of the inspection block BLK and the inspection page PG in this block BLK to be checked are updated every time the host 1 issues a read request to the memory card 2. That is, the data error correction may be performed evenly on the blocks BLK and pages PG in all the zones Zn. Thus, the use capacity of the RAM 14 may be reduced, and the read-disturb during data read can be suppressed.

### Second Embodiment

Now, a memory system and a control method for the memory system according to a second embodiment will be described. In the above-described first embodiment, every time the host 1 issues a read command, for example, CMD17 or CMD18, to the memory card 2, the logical address of a block BLK in a inspection address table 25 is incremented by 1 bit. Furthermore, when read is executed on the last block address, the logical addresses of both the block BLK and the page PG corresponding to this block BLK are incremented by 1 bit. Additionally, if the host 1 issues a write request to the memory card 2, the data in the check inspection table 25 is stored in a system data area 21.

In contrast, in the present embodiment, every time a memory card 2 is turned on, the logical address of the block BLK in the inspection address table 25 is incremented by 1 bit. Furthermore, if read is executed on the last block address of a zone, the logical addresses of the block BLK and the page PG corresponding to the block BLK are incremented by 1 bit.

The memory controller 2 according to the present embodiment is assumed to be used for the host 1 configured to issue no particular write request but many read requests. A specific example of such a host 1 is a game apparatus. The same components of the present embodiment as those of the above-described first embodiment will not be described.

FIG. 10 shows the internal configuration of the RAM 14 included in the memory card 2 according to the present embodiment. As shown in FIG. 10, the RAM 14 may hold the inspection address table 25 and number-of-times data 31.

The number-of-times data 31 indicates the number of times that the host 1 has powered the memory card 1 via the SD interface 11. As described above, the MPU 12 may detect that the memory card 2 has been powered on. That is, the MPU 12 functions as a detector for detecting the number of times that the memory card 2 has been powered on. This is achieved by allowing an SD interface 11 to receive a command ACMD41. After being powered on and receiving ACMD41, the MPU 12 reads from the system data area 21 and stores the number-of-times data 31 in the RAM 14. Moreover, the MPU 12 counts up the value of the number-of-times data 31. The MPU 12 generates data for the inspection address table 25 in accordance with the value of the number-of-times data 31. That is, instead of being read from the system data area 21 and stored in the inspection address table 25, the data for the inspection address table 25 is generated by the MPU 12 based on the value of the number-of-times data 31 every time the memory card 31 is powered on. Simultaneously with power-off of the memory card 2, the data in the inspection address table 25 stored in the RAM 14 is initialized. Furthermore, the number-of-times data 31 is stored in the system area 21 of the flash memory 6.

Furthermore, the inspection address table 25 includes the elements described in the first embodiment. That is, the inspection address table 25 includes, for example, information indicating, for each of the 30 zones Zn, which page PG in any of the block BLK is to be checked.

### <Increment Operation Performed on the Inspection Address Table 25 (2)>

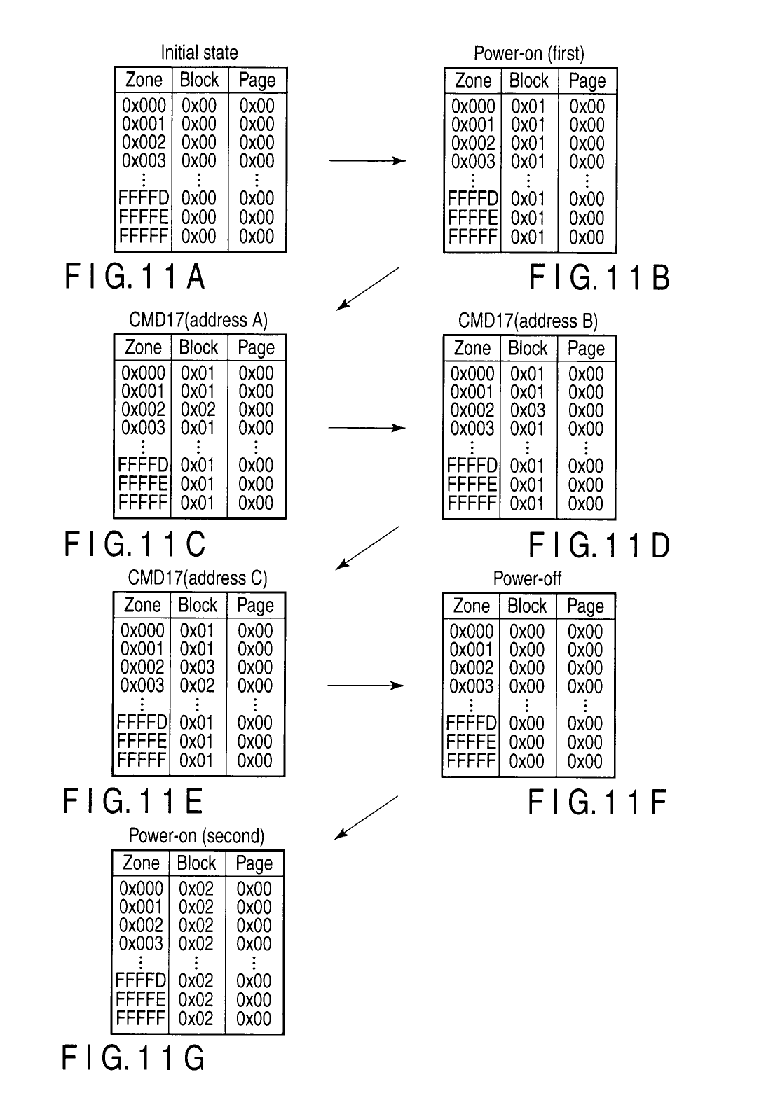

An increment operation performed on the blocks BLK and pages PG in each zone Zn stored in the inspection address table 25 held by the RAM 14 will be described with reference to FIGS. 11A to 11G. Here, it is assumed that the memory card 2 is powered on by the host 1 via the SD interface 11 and that the host 1 then requests a read of data held by the flash memory 6.

As in the above-described first embodiment, when CMD17 or CMD18 is output by the host 1, the MPU 12 references the inspection address table 25 to allow the ECC circuit 16 to correct the data held by the memory cells in the page PG, for possible errors, as shown in FIG. 6. Thereafter, the MPU 12 performs the refresh operation as required, and then performs the operations in steps S11 to S14 on the read data.

### <FIG. 11A>

FIG. 11A shows a inspection address table 25 formed in the RAM 14 when the memory card 2 is powered on. The MPU 12 generates a inspection address table 25 in which the blocks BLK and pages PG in each zone Zn have the leading address. In other words, when the memory card 2 is powered on, the MPU 12 generates a inspection address table 25 in which all the addresses have the initial value ‘0x00’. This corresponds to an initial state.

### <FIG. 11B>

Then, as shown in FIG. 11B, upon detecting, via the SD interface 11, that the memory card 2 has been turned on, the MPU 12 loads the number-of-times data 31 held in the system data area 21, onto the RAM 14. Thereafter, the MPU 12 increments the count value of the number-of-times data 31 by +1. It is assumed that the value of the number-of-times data 31 is zero before the memory card 2 is powered on. That is, the MPU 12 externally detects power-on to set the value of the number-of-times data 31 to ‘1’.

MPU 12 increments the logical address of the block BLK in each zone Zn in the inspection address table 25, which address is currently set equal to the leading address, by 1 bit (in the figure, the resulting address is shown as 0x01). That is, upon every power-on, the MPU 12 increments the block address in the inspection address table 25 by a number equal to the value of the number-of-times data 31 obtained upon the power-on.

### <FIG. 11C>

It is assumed that the host 1 then issues a data read request to the memory card 2. That is, it is assumed that the host 1 transfers CMD17 (a read request intended for the SD interface) to the memory card 2. Here, the read address is assumed to be “Address A”. It is assumed that this address is included in the third zone Zn from its leading address. Thus, as described above, the MPU 12 allows the ECC circuit 16 to perform error correction, with the page PG (0x00) of the block BLK (0x01) and with the block BLK (0x01) belongs to zone Zn (0x003) that is set to be checked. Thereafter, as shown in FIG. 11C, the MPU 12 increments the logical address of the block BLK in the corresponding zone Zn by 1 bit (in the figure, the resulting address is shown as 0x02).

### <FIG. 11D>

Then, it is assumed that the host 1 transfers CMD17 to the memory card 2 again as shown in FIG. 11D. Here, the read address is assumed to be “Address B”. Also in this case, it is assumed that this address is included in the third zone Zn. Thus, as is the case with FIG. 11C, the MPU 12 increments the logical address of the block BLK in the third zone Zn by 1 bit (in the figure, the resulting address is shown as 0x03).

### <FIG. 11E>

Moreover, it is assumed that the host 1 transfers CMD17 to the memory card 2 as shown in FIG. 11E. Here, the read address is assumed to be “Address C”. It is assumed that this address is included in the fourth zone Zn. Thus, after the ECC circuit 16 performs error correction, the MPU 12 increments the logical address of the block BLK in the fourth zone Zn by 1 bit (in the figure, the resulting address is shown as 0x02).

### <FIG. 11F>

Thereafter, as shown in FIG. 11F, when the memory card 2 is powered off, the data in the inspection address table 25 generated in the RAM 14 is initialized. That is, the data on the logical addresses of the blocks BLK and pages PG held in the check inspection address table 25 is initialized such that each of the logical addresses returns to the initial address (in the figure, the resulting address is shown as 0x00). That is, the inspection address table 25 is brought into the initial state shown in FIG. 11A. At this time, the number-of-times data 31 is stored in the system area 21 in the flash memory 6.

### <FIG. 11G>

Then, upon detecting, via the SD interface 11, that the memory card 2 has been powered on again, the MPU 12 loads the value of the number-of-times data 31 stored in the system data area 21, onto the RAM 14. Here, the value of the number-of-times data 31 stored in the system data area 21 is ‘1’. Thus, when the data is loaded onto the RAM 14, the count value is incremented by +1 to ‘2’. Then, the inspection address table 25 loaded onto the RAM 14 is as shown in FIG. 11G. That is, since the value of the number-of-times data 31 is ‘2’, the block address in the inspection address table 25 is incremented by ‘2’. As a result, for all the zones Zn, the block address value of the inspection block is set to ‘0x02’. In other words, when powered on, the MPU 12 generates again a inspection address table 25 in which all the addresses have the initial value ‘0x00’. The MPU 12 references the number-of-times data 31 to update the initial value to ‘0x02’.

Thereafter, when the host 1 issues CMD17 for a request, the address of the corresponding block BLK or the addresses of the corresponding block BLK and the page PG in this block BLK are incremented by 1 bit as shown in FIGS. 11C to 11E described above.

As shown in FIGS. 11A to 11G described above, when the logical address of a certain block BLK already changed from “00x0” to “0xff” (last block address) returns to “00x0”, the logical address of the page PG in the block BLK are incremented by +1 bit.

### Effects of the Present Embodiment

The memory system and the control method for the memory system according to the present embodiment may also exert an effect (1) similar to that of the above-described first embodiment. That is, in the above-described first embodiment, when the host 1 outputs the read request command (CMD17, 18), the block address in the inspection address table 25 stored in the RAM 14 is incremented. Thus, error correction may be performed evenly on all the memory cells in the flash memory 6.

In the present embodiment, the number-of-times data 31 is held in the system data area 21, and upon power-on, a inspection address table 25 is generated based on the number-of-times data 31. Then, even if the host 1 outputs almost no command for a write request and the inspection address table 25 stored in the RAM 14 is initialized upon power-off, error correction may be performed evenly on all the memory cells in the flash memory 6. This is because the number-of-times data 31 is held by the RAM 14 such that data for a inspection address table 25 initialized in accordance with the count value of the number-of-times data 31 may be generated. As described above in the first embodiment, the inspection address table 25 holds only a small amount of data, that is, 1,024 bytes per zone Zn.

Furthermore, the number-of-times data 31 indicates the number of times that the memory card 2 has been powered on so that data for the inspection address table 25 is generated in accordance with the value of the number of times. Then, data similar to that obtained before initialization may be provided to the inspection address table 25. Thus, even when the memory card 1 is inserted into the host 2 involving almost no write request and reads data, read-disturb may be suppressed with a reduction in the capacity of data used by the RAM 14.

### Third Embodiment

Now, a third embodiment will be described. In the above-described first embodiment, every time a read request is issued, the inspection address table 25 is referenced, and error correction is performed on the memory cells in the page PG to be checked and the memory cell corresponding to the read address.

In contrast, the present embodiment corresponds to the in the above-described first embodiment configured such that when the number of reads reaches a specified number N (N: a natural number greater than or equal to 2), MPU 12 references the inspection address table 25, and instructs an ECC circuit 16 to correct error data held by the memory cells in the page PG to be checked.

That is, until the number of data read requests from the host 1 reaches the specified value N, the MPU 12 avoids referencing the inspection address table 25, reads data from the memory cells corresponding to the address in the read request from the host 1, and then allows the ECC circuit 16 to correct the data for possible errors. That is, the present embodiment is configured to be able to load, onto the RAM 14, an area in which the number of read requests can be held (this area is hereinafter referred to as read request counter 40). The same components of the third embodiment as those of the first embodiment are denoted by the same reference numbers and will not be described below.

### CONFIGURATION EXAMPLE

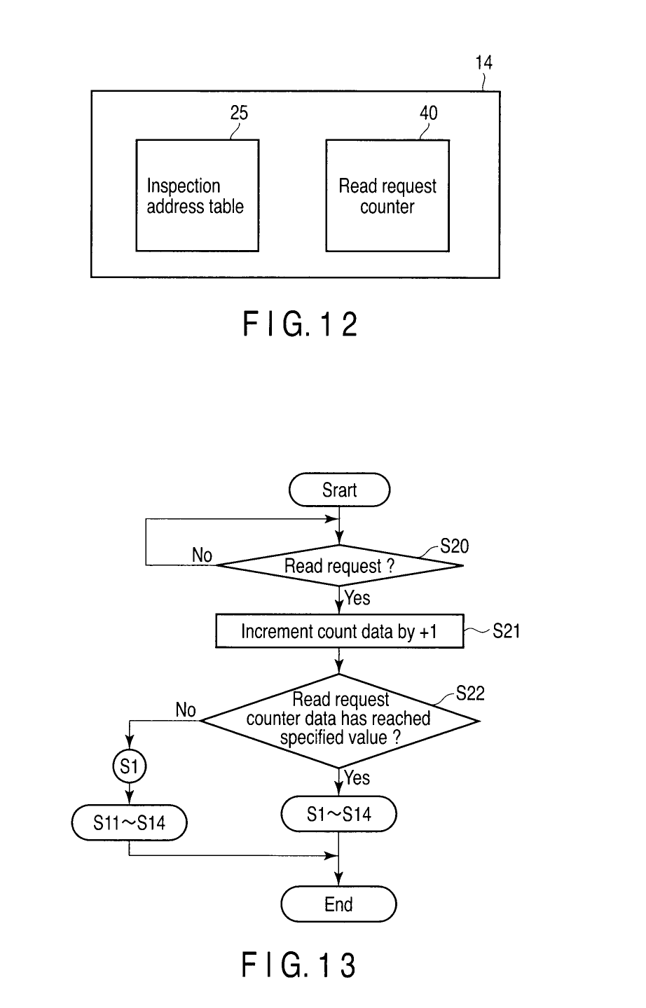

FIG. 12 shows the internal configuration of the RAM 14 provided in the memory card 2 according to the present embodiment.

As shown in FIG. 12, the RAM 14 can hold not only the inspection address table 25 but also the read request counter 40. As described above, the read request counter 40 is the value of the number of times (hereinafter sometimes referred to as the number of read requests) that the host 1 has issued read requests. That is, the read request counter 40 is the value counted up by the MPU 12 when the host outputs a read request.

### <Operation of the Memory Card 2 (MPU 12) (2)>

Now, the operation of the memory card 2 (particularly the MPU 12) will be described with reference to FIG. 13. FIG. 13 is a flowchart showing the operation of the MPU 12 performed when the host 1 issues a read request to the memory card 2.

Upon receiving a read request command (for example, CMD17 or CMD18) from the host 1 (S20, YES), the MPU 12 increments the value of the read request counter 40 in the RAM 14 by +1 (S21). Then, the MPU 12 determines whether or not the value of the read request counter 40 has reached the specified value N (S22).

In step S22, if the value of the read request counter 40 reaches the specified value N (S22, YES), that is, if the number of read requests equals the value of the read request counter 40 having reached the specified value N, the MPU 12 performs the operations in steps S1 to S14 in FIG. 6.

That is, when the host 1 transfers a read request command to the memory card 2, the MPU 12 searches the zone Zn including the read address to set the pages PG in the blocks BLK in the zone Zn to be check targets.

Thereafter, the MPU 12 performs a refresh operation on the block BLK including the page PG as required. The MPU 12 increments the block addresses in the inspection address table 25 by +1 bit. Thereafter, the MPU 12 reads data from the memory cells corresponding to the address in the read request from the host 1. The MPU 12 then allows the ECC circuit 16 to correct the data for possible errors. Then, the MPU 12 outputs the read data to the host 1.

Furthermore, in step S22 shown in FIG. 13, if the value of the read request counter 40 is below the specified value N (S22, NO), the MPU 12 avoids referencing the inspection address table 25. That is, after acquiring the address from the read request, the MPU 12 reads data from the memory cells corresponding to the address. Then, the MPU 12 allows the ECC circuit 16 to correct the read data for possible errors (steps S11 to S14).

That is, if the value of the read request counter 40 is below the specified value N, the adverse effect of read-disturb is insignificant. Thus, the MPU 12 searches for the zone Zn including the address transferred by the host 1. The MPU 12 avoids performing error correction on the data held by the memory cells corresponding to the inspection block BLK and page PG in the corresponding zone.

### Effects of the Present Embodiment

The memory system and the control method for the memory system according to the present embodiment can exert not only the above-described effect (1) but also an effect (2) described below.

(2) The present embodiment may reduce the amount of time from reception of a data read request command from the host 1 until the read data is transferred to the host 1.

This is because if the number of reads is below the specified value, the MPU 12 avoids reading the page data from the inspection address table. That is, according to the present embodiment, the read request counter 40 is provided in the RAM 14. In the memory system according to the present embodiment, when the value of the read request counter 40 reaches the specified value N, the MPU 12 references the inspection address table 25 based on the address in the read request command. The MPU 12 then performs the operations in steps S1 to S14 according to the above-described first embodiment.

Without the read request counter 40, upon every reception of a read request, the MPU 12 references the check inspection table 25 to correct the page PG including the inspection address for possible errors. That is, the number of times that the MPU 12 references the inspection address table 25 to allow error correction to be performed increases consistently with the number of read requests from the host 1. This increases the time required until the next read operation can be started.

However, in the memory system and the control method for the memory system according to the present embodiment, the MPU 12 counts the number of read requests from the host 1 and avoids referencing the inspection address table 25 until the count value is below the specified value N. This enables a reduction in the time required for the MPU 12 to reference the inspection address table 25 in accordance with a read request and perform error correction on the page PG including the inspection address.

Here, a specific number is assigned to the specified value N. For example, the specified value N=2. In this case, for every two read requests, the MPU 12 references the inspection address table 25 and performs one error correction. This enables a reduction in time by a value corresponding to one error correction compared to the case where for every read request, the MPU 12 references the inspection address table 25 and performs one error correction.

When the specified value N=t (t≧2), the time can be reduced by a value corresponding to “(t−1)” error corrections.

Furthermore, when the value of the read request counter 40 reaches the specified value N, the MPU 12 references the inspection address table 25 and performs error correction on the inspection page address. Thus, the frequency at which the inspection address table 25 is referenced decreases with increasing specified value N. That is, power consumption may be reduced which is required to reference the inspection address table and correct the data held by the memory cells in the corresponding page PG for possible errors.

### Fourth Embodiment

Now, a fourth embodiment will be described. In the above-described second embodiment, a inspection address table 25 is generated depending on the number of power-on operations. Thereafter, when a read request is issued, the MPU 12 references the inspection address table 25 generated based on the number-of-times data 31, and allows error correction to be performed on the memory cells in the inspection page PG. The MPU 12 then also corrects the data held by the memory cells corresponding to the read address, for possible errors.

In contrast, the present embodiment corresponds to the above-described second embodiment in which when the number of reads reaches a specified value N (N: a natural number greater than or equal to 2), the MPU 12 references the inspection address table 25 and corrects the data held by the memory cells in the inspection page PG. That is, until the number of data read requests from a host 1 reaches the specified value N, the MPU 12 avoids referencing the inspection address table 25, reads data from the memory cells corresponding to the address in the read request from the host 1, and allows an ECC circuit 16 to correct the data for possible errors.

In the present embodiment, in addition to the inspection address table 25 and the number-of-times data 31, read request counter 40 indicative of the counted number of read requests is provided in the RAM 14. The value of the read request counter 40 is assumed to be loaded onto the RAM 14. The count value is assumed to be counted by the MPU 12. The same components of the fourth embodiment as those of the second embodiment will not be described below. Furthermore, the same components are denoted by the same reference numbers.

### CONFIGURATION EXAMPLE

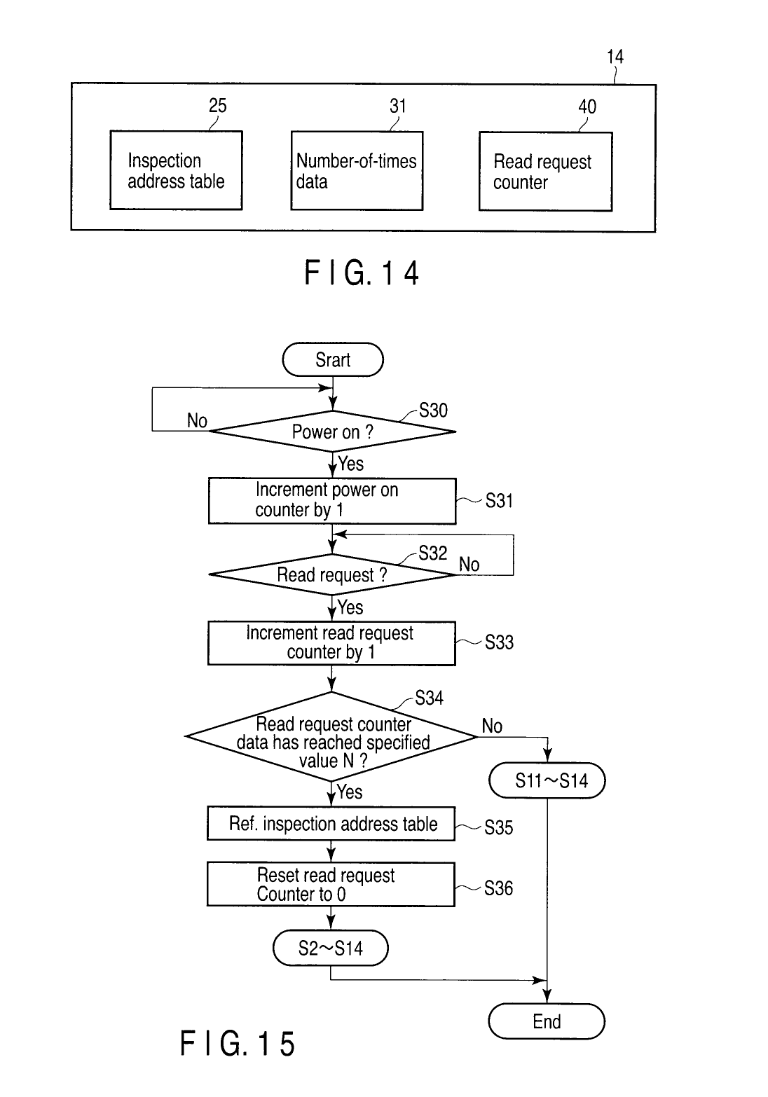

FIG. 14 shows the internal configuration of the RAM 14 provided in the memory card 2 according to the present embodiment. FIG. 14 is a block diagram of the RAM 14.

As shown in FIG. 14, the RAM 14 can hold not only the inspection address table 25 and the number-of-times data 31 but also the read request counter 40. As described above, the read request counter 40 is the number of times that the host 1 has issued read requests. The read request counter 40 is the value counted by the MPU 12 when the host transfers a read request command to the memory card 2.

### <Operation of the Memory Card 2 (MPU 12)>

Now, the operation of the memory system and the control method for the memory system according to the present embodiment will be described with reference to FIG. 15. FIG. 15 is a flowchart showing the operation of the memory system (particularly the MPU 12) performed when the memory card 2 is turned on and if the host 1 issues a read request command to the memory card 2.

As shown in FIG. 15, when the standing-by memory card 2 is powered on (S30, YES), the MPU 12 increments the value of the number-of-times data 31 loaded on the RAM 14, by +1 (S31). Furthermore, in step S30, if the memory card 2 remains off, the MPU 12 stands by until the memory card 2 is turned on (S30, NO). Thereafter, when the host 1 issues a read request command to the memory card 2 (S32, YES), the MPU 12 increments the read request counter 40 by +1 (S33). Furthermore, in step S32, if the host 1 issues no read request command after power-on (S32, NO), the MPU 12 stands by until the host 1 transfers a data read request command to the memory card 2 (S32, NO).

Then, the MPU 12 compares the value of the read request counter 40 with the specified value N (S34). As a result, upon determining that the value of the read request counter 40 has reached the specified value N (S34, YES), the MPU 12 references the inspection address table 25 generated in accordance with the value of the number-of-times data 31 incremented in step S31, to execute a predetermined process (S35). That is, the MPU 12 reads data from the memory cells corresponding to the inspection block BLK and page PG in the zone Zn including the read address. The MPU 12 allows the ECC circuit 16 to correct the data for possible errors. For example, the operations in FIGS. 11C and 11D described above in the second embodiment are performed.

Thereafter, the MPU 12 resets the value of the read request counter 40 to ‘0’ (S36). The MPU 12 then executes the processing in steps S2 to S14 shown in FIG. 6.

Moreover, if the value of the read request counter 40 has not reached the specified value N, the MPU 12 executes the processing in steps S11 to S14 shown in FIG. 6. That is, the MPU 12 reads data from the memory cells corresponding to the address in the read data received from the host 1. Thereafter, the MPU 12 allows the ECC circuit 16 to correct the read data for possible errors. The MPU 12 further allows the data with errors corrected to be output to the host 1.

### Effects of the Present Embodiment

The present embodiment can exert the above-described effects (1) and (2). That is, read disturbance can be suppressed with a reduction in the capacity consumption of the RAM 14. Moreover, the amount of time from reception of a data read request from the host 1 until transfer of the read data to the host 1 can be reduced.

That is, according to the present embodiment, the RAM 14 holds the read request counter 40. When the number of read request commands from the host 1 reaches the specified value N, the MPU 12 performs error correction on the inspection address. Namely, even with an increase in the number of read requests from the host 1, MPU 12 avoids referencing the inspection address table 25 and performing error correction on the inspection address until the number reaches the set specified value N. Thus, even with an increase in the number of read requests, data can be read faster, enabling a reduction in time.

The memory system and the control method for the memory system according to the first to fourth embodiments have been described. In the first to fourth embodiments, for example, in order to mainly suppress read-disturb, for example, the memory system described in the first and second embodiments is adopted. For example, in order to mainly reduce the mount of time, for example, the memory system described in the third and fourth embodiments is adopted. In this manner, the required embodiment may be selected for a particular purpose.

In the memory system and the control method for the memory system according to the first and second embodiments, the incrementation in the inspection address table is based on the logical addresses. However, the incrementation may be based on physical addresses. That is, provided that the ECC circuit 16 performs error correction evenly on all the memory cells, any manner may be used to increment the logical addresses of the block BLK and the page PG in this block BLK.

Furthermore, in the above-described embodiments for the memory system and the control method for the memory system, the memory system is a memory card with an SD interface card, for example, an SD memory card. However, the application of the above-described embodiments is not limited to the SD memory card. The embodiments are widely applicable to any systems including a NAND flash memory and a controller configured to control the NAND flash memory. Furthermore, the semiconductor memory provided in the memory system may be any flash memory other than the NAND type, for example, a NOR flash memory.

Alternatively, any other semiconductor memory may be used provided that the number of rewrites affects the operating reliability of the memory.

Furthermore, in the above-described embodiments, the addresses of the inspection block and page are incremented. However, the addresses may be decremented. The step of the increment or decrement may be 2 bits instead of 1 bit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a semiconductor memory which includes a plurality of NAND strings, each of the NAND strings including a plurality of memory cells connected in series, each memory cell being capable of holding data, wherein writing and reading of data in the memory cells is performed in unit of a page corresponding to a set of the memory cells belonging to different NAND strings and erasing of data in the memory cells is performed in unit of a block corresponding to a set of the plurality of NAND strings; and
a controller which controls the semiconductor memory, the controller including
a storing unit which stores an inspection address table in which information on an inspection page for each zone corresponding to a set of the blocks is recorded, and
a control unit which refers the inspection address table stored in the storing unit to calculate an occurrence rate of a read error for the inspection page in the zone including a read target page when the data is read from the semiconductor memory, and which instructs the semiconductor memory to write the data in the block including the inspection page to another block in the semiconductor memory, if the occurrence rate exceeds a preset threshold.

2. The system according to claim 1, wherein after calculating the occurrence rate,
the control unit
updates the inspection page in the zone including the read target page to any page in a different block, and
then reads the data from the read target page.

3. The system according to claim 2, wherein the control unit
calculates the occurrence rate of a read error in the data read from the read target page, and
performs a shift read on one of the memory cells holding the data exceeding the threshold, if the occurrence rate exceeds a preset threshold.

4. The system according to claim 1, wherein the information recorded in the inspection address table includes a page address of the inspection page and a block address of the block including the inspection page, and
the control unit increments the block address in the inspection address table by “1” to update the inspection page.

5. The system according to claim 4, wherein if the block address in the inspection address table is a last block address in the zone,
the control unit
changes the block address to a leading block address in the zone, and
increments the page address by “1” to update the inspection page.

6. The system according to claim 1, wherein the semiconductor memory includes a system area which holds the inspection address table, and
the control unit writes the information held in the inspection address table, to the system area when the data is written to the semiconductor memory.

7. The system according to claim 1, wherein the storing unit further comprises count data, and
the control unit
increments a value of the count data by “1” every time a read of the data is requested, and
references the inspection address table, when the value of the incremented count data reaches a specified value to calculate the occurrence rate.

8. The system according to claim 7, wherein after calculating the occurrence rate, and
the control unit
updates the inspection page in the zone including the read target page to any page in a different block, and
then reads the data from the read target page.

9. A memory system comprising:
a semiconductor memory which includes a plurality of NAND strings, each of the NAND strings including a plurality of memory cells connected in series, wherein writing and reading of data in the memory cells is performed in unit of a page corresponding to a set of the memory cells belonging to different NAND strings and erasing of data in the memory cells is performed in unit of a block corresponding to a set of a plurality of NAND strings; and
a controller which controls the semiconductor memory; the controller including
a storing unit which stores
an inspection address table in which information on an inspection page for each zone corresponding to a set of the blocks is recorded, and
a number of times which the memory system has been powered on,
a detector which detects that the memory system has been powered on, and
a control unit which counts the number of times every time the detector detects that the memory system has been powered on, and which generates the inspection address table in accordance with the number of times, the control unit referring the inspection address table to calculate an occurrence rate of a read error for the inspection page in the zone including a read target page when the data is read from the semiconductor memory, control unit instructing the semiconductor memory to write the data in the block including the inspection page to another block in the semiconductor memory, if the occurrence rate exceeds a preset threshold.

10. The system according to claim 9, wherein the semiconductor memory includes a system area which stores the number of times, and
every time the memory system is powered on, the control unit
reads the number of times from the system area onto the storing unit, counts up the number of times, and
then writes the counted-up the number of times to the system area.

11. The system according to claim 9, wherein after calculating the occurrence rate,
the control unit
updates the inspection page in the zone including the read target page to any page in a different block, and
reads the data from the read target page.

12. The system according to claim 11, wherein the control unit
calculates the occurrence rate of a read error in the data read from the read target page, and
if the occurrence rate exceeds a preset threshold,
performs a shift read on one of the memory cells holding the data exceeding the threshold.

13. The system according to claim 9, wherein the information recorded in the inspection address table includes a page address of the inspection page and a block address of the block including the page, and
the control unit increments the block address in the inspection address table by “1” to update the inspection page.

14. The system according to claim 13, wherein if the block address in the inspection address table is a last block address in the zone,
the control unit
changes the block address to a leading block address in the zone, and
increments the page address by “1” to update the inspection page.

15. The system according to claim 9, wherein the storing unit further comprises count data,
the control unit
increments a value of the count data by “1” every time a read of the data is requested, and
references the inspection address table when the value of the incremented count data reaches a specified value.

16. The system according to claim 15, wherein after calculating the occurrence rate,
the control unit
updates the inspection page in the zone including the read target page to any page in a different block, and
reads the data from the read target page.

17. A control method for a memory system including a semiconductor memory and a controller, the semiconductor memory including a plurality of NAND strings, each of the NAND string including the plurality of memory cells connected in series, each memory cell being capable of holding data, wherein writing and reading of data in the cells is performed in unit of a page corresponding to a set of the memory cells belonging to the different NAND strings and erasing of data in the memory cells is performed in unit of a block corresponding to a set of the plurality of NAND strings, the method comprising:
referring to an inspection address table, which holds information on an inspection page for each zone corresponding to a set of the blocks when request for a read of data held by a semiconductor memory is issued;
calculating an occurrence rate of a read error for the inspection page in the zone including the page serving as a read target, and
instructing the semiconductor memory to write the data in the block including the inspection page to another block, if the occurrence rate exceeds a preset threshold.

18. The method according to claim 17, wherein after the calculating the occurrence rate,
the method further comprising:
updating the inspection page in the zone including the read target page to any page in a different block; and
reading the data from the read target page after updating the inspection page.

19. The method according to claim 17, wherein the information recorded in the inspection address table includes a page address of the inspection page and a block address of the block including the inspection page, and
the method further comprising:
incrementing the block address in the inspection address table by “1” to update the inspection page.

20. The method according to claim 17, wherein if the block address in the inspection address table is a last block address in the zone,
the method further comprising:
changing the block address to a leading block address in the zone; and
incrementing the page address by “1” to update the inspection page.
